(19) United States
(12) Patent Application Publication
(10) Pub. No.: US 2023/0209023 A1
(43) Pub. Date: Jun. 29, 2023

(54) LIGHT SOURCE ASSEMBLY, OPTICAL ENGINE, AND PROJECTOR

(71) Applicant: HISENSE LASER DISPLAY CO., LTD., Shandong (CN)

(72) Inventor: Longfei Shi, Shandong (CN)

(21) Appl. No.: 18/170,743

(22) Filed: Feb. 17, 2023

Related U.S. Application Data
(63) Continuation of application No. PCT/CN2021/116103, filed on Sep. 2, 2021.

(30) Foreign Application Priority Data
Oct. 14, 2020 (CN) 202011094811.4
Oct. 14, 2020 (CN) 202011098719.5

(51) Int. Cl. H04N 9/31

(52) U.S. Cl. CPC H04N 9/3105; H04N 9/317; H04N 9/3152; H04N 9/3161; H04N 9/3144; H04N 9/3155

(57) ABSTRACT

The present application provides a light source assembly, an optical engine, and a projector. The light source assembly includes a first housing, a second housing, multiple lasers, multiple beam combination mirror groups, a convex lens, a reflector, a concave lens, an angle adjustment element, and a converging lens. The first housing has multiple light inlets corresponding one-to-one to the multiple lasers, and a light outlet. Each of the lasers is disposed at a corresponding light inlet. The multiple beam combination mirror groups are disposed in the first housing. The second housing has a light inlet and a light outlet, and the light outlet of the first housing is connected with the light inlet of the second housing. The reflector, the concave lens, and the angle adjustment element are disposed in the second housing. The converging lens is disposed at the light outlet of the second housing.

### CROSS-REFERENCE OF RELATED APPLICATIONS

The application is a continuation application of International Application No. PCT/CN2021/116103 filed Sep. 02, 2021, which claims the priorities from Chinese Patent Application No. 202011098719.5 and Chinese Patent Application No. 202011094811.4 filed on Oct. 14, 2020, which are hereby incorporated by reference in their entirety.

### TECHNICAL FIELD

The disclosure relates to the field of optoelectronic technology, and in particular, to a light source assembly, an optical engine and a projector.

### BACKGROUND

With the development of optoelectronic technology, the requirements for miniaturization of a projector and better display effect of projection images are getting higher.

The laser projector includes a laser source assembly, an optical engine assembly and a lens assembly. The laser source assembly provides excited beams, etc., the optical engine assembly modulates the beams emitted from laser light source assembly and emits the beams to the lens assembly, and the lens assembly projects the beams to display an image.

### SUMMARY

In an aspect, some embodiments of the disclosure provide a light source assembly, including: a first housing, a second housing, a plurality of lasers, a plurality of beam combination mirror groups, a convex lens, a reflector, a concave lens, an angle adjustment element and a converging lens. The first housing has a plurality of light inlets in one-to-one correspondence to the plurality of lasers and a light outlet, each of the lasers is disposed at a corresponding light inlet, and the plurality of beam combination mirror groups are disposed in the first housing. The second housing has a light inlet and a light outlet, and the light outlet of the first housing is connected with the light inlet of the second housing. The reflector, the concave lens and the angle adjustment element are disposed in the second housing, and the converging lens is disposed at the light outlet of the second housing. The lasers are configured to emit laser light to the corresponding beam combination mirror groups, the beam combination mirror groups are configured to mix and reflect the incident laser light to the convex lens, the convex lens is configured to converge the incident laser light to the reflector, and the reflector is configured to reflect the incident laser light. As such, the laser light is emitted out after passing through the concave lens, the angle adjustment element and the converging lens in sequence.

In another aspect, some embodiments of the disclosure provide an optical engine, including: the above-mentioned light source assembly, a light modulation assembly and a lens.

In yet another aspect, some embodiments of the disclosure provide a projector, including: the above-mentioned optical engine, a circuit board of power supply, a circuit board for display control and a heat dissipation structure.

### BRIEF DESCRIPTION OF THE DRAWINGS

In order to illustrate the technical solutions in the embodiments of the disclosure more clearly, the accompanying figures which need to be used in describing the embodiments will be introduced below briefly. Obviously the accompanying figures described below are only some embodiments of the disclosure, and other accompanying figures can also be obtained by those ordinary skilled in the art according to these accompanying figures without creative labor.

FIG. 1 shows a structural schematic diagram of a light source assembly provided in the related art.

FIG. 2 shows a structural schematic diagram of a light source assembly according to some embodiments of the disclosure.

FIG. 3 shows a structural schematic diagram of a light source assembly according to some embodiments of the disclosure.

FIG. 4 shows an optical path diagram of laser transmission in a light source assembly according to some embodiments of the disclosure.

FIG. 5 shows a structural schematic diagram of a first light source body according to some embodiments of the disclosure.

FIG. 6 shows a structural schematic diagram of a first light source body according to some embodiments of the disclosure.

FIG. 7 shows a structural schematic diagram of a second light source body according to some embodiments of the disclosure.

FIG. 8 shows a structural schematic diagram of a second light source body according to some embodiments of the disclosure.

FIG. 9 shows a structural schematic diagram of a laser according to some embodiments of the disclosure.

FIG. 10 shows a structural schematic diagram of a laser according to some embodiments of the disclosure.

FIG. 11 shows a structural schematic diagram of a light source assembly according to some embodiments of the disclosure.

FIG. 12 shows a structural schematic diagram of a light source assembly according to some embodiments of the disclosure.

FIG. 13 shows a structural schematic diagram of a first light source body according to some embodiments of the disclosure.

FIG. 14 shows a structural schematic diagram of a welding fixture according to some embodiments of the disclosure.

FIG. 15 shows a schematic diagram illustrating the assembly of a laser and a printed circuit board according to some embodiments of the disclosure.

FIG. 16 shows a schematic diagram of a laser and a printed circuit board during an assembly process according to some embodiments of the disclosure.

FIG. 17 shows a schematic diagram of a partial structure of a first light source body according to some embodiments of the disclosure.

FIG. 18 shows a schematic diagram of a partial structure of a first light source body according to some embodiments of the disclosure.

FIG. 19 shows a structural schematic diagram of a second light source body according to some embodiments of the disclosure.

FIG. 20 shows a structural schematic diagram of a light source assembly according to some embodiments of the disclosure.

FIG. 21 shows a structural schematic diagram of an optical engine according to some embodiments of the disclosure.

FIG. 22 shows a structural schematic diagram of an optical engine according to some embodiments of the disclosure.

FIG. 23 shows a structural schematic diagram of a projector according to some embodiments of the disclosure.

### DETAILED DESCRIPTION

In order to make the objects, technical solutions and advantages of the disclosure clearer, the embodiments of the disclosure will be further illustrated below in details with reference to the accompanying drawings.

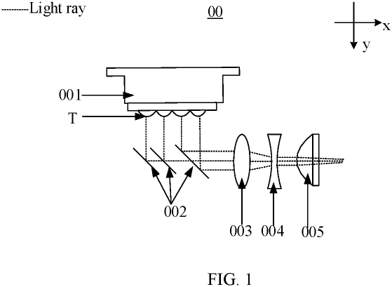

An optical engine in a projector is configured for image projection. The optical engine includes: a light source assembly, a light modulation assembly and a lens. The light source assembly is configured to emit light and transmit the light to the light modulation assembly, the light modulation assembly is configured to modulate the light according to an image to be displayed and then transmit the modulated light to the lens, and the lens is configured to project the modulated light to form the projection image. In the related art, as shown in FIG. 1, the light source assembly includes: a laser 001 fixed to a housing, a beam combination mirror group 002, a convex lens 003, a concave lens 004 and a converging lens 005. The beam combination mirror group 002, the convex lens 003, the concave lens 004, the converging lens 005, the light modulation assembly (not shown in FIG. 1) and the lens (not shown in FIG. 1) are disposed in sequence in the direction (x direction in the figure) perpendicular to the light-emitting direction (y direction in the figure) of the laser 001. Laser beams are emitted by the laser 001 to the beam combination mirror group 002, mixed by the beam combination mirror 002 and reflect off the beam combination mirror 002 to the convex lens 003. The convex lens 003 converges the incident laser beams to the concave lens 004, the concave lens 004 collimates the incident laser beams and then transmits them to the converging lens 005, the converging lens 005 converges the incident laser beams to the light modulation assembly, and the light modulation assembly transmits the incident laser beams to the lens.

However, in the related art, many elements are fixed in one housing of the light source assembly, and the assembly thereof is relatively difficult. The brightness of the projection image is relatively low, and the display effect of the projection image is relatively poor. In addition to the above structures, the projector further includes a power assembly, a sound assembly, a heat dissipation fan and other structures. Since the projector includes many structures and the structures as a whole need to occupy a relatively large space, the volume of the projector is relatively large, and it is difficult to realize the miniaturization of the projector.

With the development of optoelectronic technology, the projector is used more and more widely, and the requirements on the projector are getting higher. For example, the size of the projector is required to be as small as possible, the display effect of the projection image is required to be as better as possible, and the manufacture difficulty is required to be as low as possible. A light source assembly with less assembly difficulty provided by the following embodiments of the disclosure can ensure that the size of the projector is relatively small and the display effect of the projection image is better.

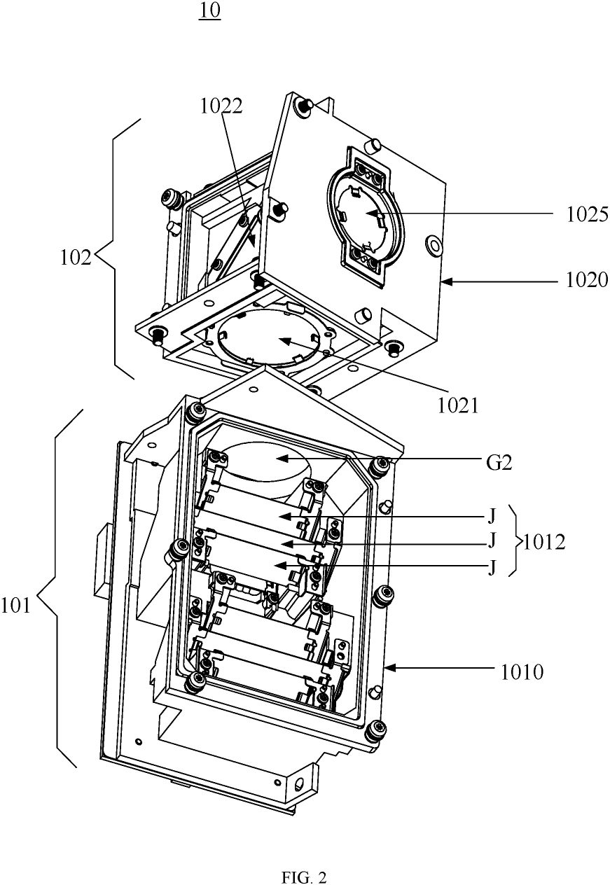

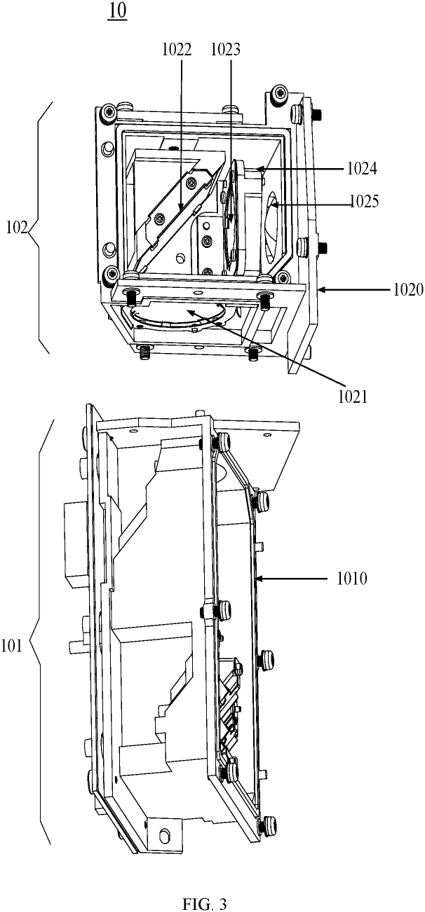

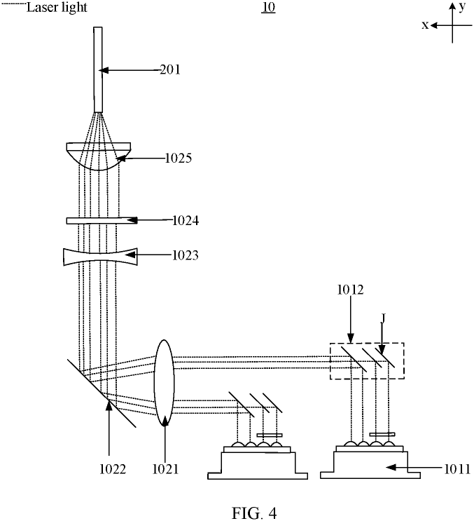

FIG. 2 shows a structural schematic diagram of a light source assembly according to some embodiments of the disclosure, and FIG. 3 shows another structural schematic diagram of the light source assembly according to some embodiments of the disclosure, where FIG. 3 shows a view of the light source assembly shown in FIG. 2 after rotating 90 degrees. FIG. 4 shows an optical path diagram of laser transmission in a light source assembly according to some embodiments of the disclosure. Referring to FIGS. 2, 3 and 4, the light source assembly 10 includes: a first housing 1010, a second housing 1020, a plurality of lasers 1011, a plurality of beam combination mirror groups 1012, a convex lens 1021, a reflector 1022, a concave lens 1023, an angle adjustment element 1024 and a converging lens 1025. The first housing 1010 has a plurality of light inlets (not shown in the figure) in one-to-one correspondence to the plurality of lasers 1011 and a light outlet G2. Each laser 1011 is disposed at a corresponding light inlet, and the plurality of beam combination mirror groups 1012 are disposed in the first housing 1010. The second housing 1020 has a light inlet and a light outlet (not shown in the figure). The light outlet G2 of the first housing 1010 is connected with the light inlet of the second housing 1020. The reflector 1022 and the concave lens 1023 are disposed in the second housing 1020, and the converging lens 1025 is disposed at the light outlet of the second housing 1020. In a possible embodiment, the angle adjustment element is a diffusion sheet or a fly-eye lens or a fly-eye lens pair or the like, which is not limited in the disclosure, as long as the angle of the light beam can be adjusted.

The laser 1011 is configured to emit laser light to the corresponding beam combination mirror group 1012. The beam combination mirror group 1012 is configured to mix and reflect the incident laser light to the convex lens 1021. The convex lens 1021 is configured to converge the incident laser light to the reflector 1022. The reflector 1022 is configured to reflect the incident laser light. As such, the laser light is then emitted out to a light modulation assembly after passing through the concave lens 1023, the angle adjustment element 1024 and the converging lens 1025 in sequence. In some embodiments of the disclosure, the light modulation assembly is disposed at the side of the converging lens 1025 away from the angle adjustment element 1024. Exemplarily, FIG. 4 shows a light pipe 201 in the light modulation assembly. Since the reflector causes the optical path of the laser light from the light source assembly to change, the optical devices in the light source assembly and the light modulation assembly can be arranged in two directions, so that the overall device arrangement of the light source assembly and the light modulation assembly is relatively compact.

In some embodiments of the disclosure, the lasers 1011 and the beam combination mirror groups 1012 are fixed to the first housing 1010; and the convex lens 1021, the reflector 1022, the concave lens 1023, the angle adjustment element 1024 and the converging lens 1025 are fixed to the second housing 1020. During installation, after all the elements are fixed in the corresponding housings, the first housing and the second housing are fixed together to complete the assembly of the light source assembly. There are fewer elements fixed in the first housing and the second housing, so the assembly of the components is less difficult.

To sum up, the light source assembly provided by some embodiments of the disclosure includes a plurality of lasers, so that the brightness of the laser light emitted by the light source assembly can be higher, and the display effect of the projection picture formed based on the laser light is better. In addition, the elements in the light source assembly are fixed to the two housings, so that the elements fixed in each housing are fewer, and the assembly of the light source assembly is less difficult. The laser light emitted by the convex lens is reflected by the reflector and then emitted to the concave lens and the converging lens, as such the transmission optical path of the laser light in the light source assembly is bent. The optical devices in the light source assembly and the light modulation assembly can be arranged in two directions, and the overall device arrangement of the light source assembly and the light modulation assembly is relatively compact, so the size of the projector with such light source assembly can be relatively small.

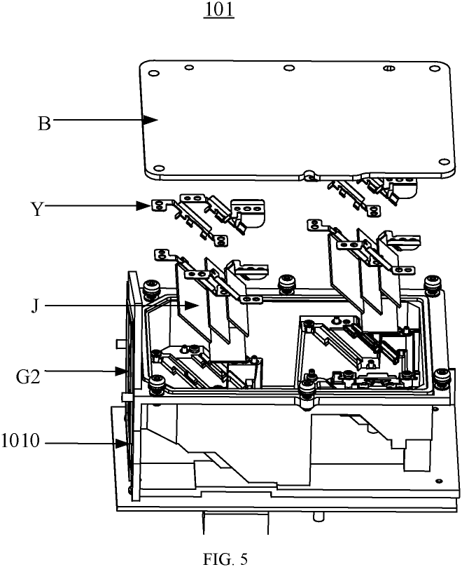

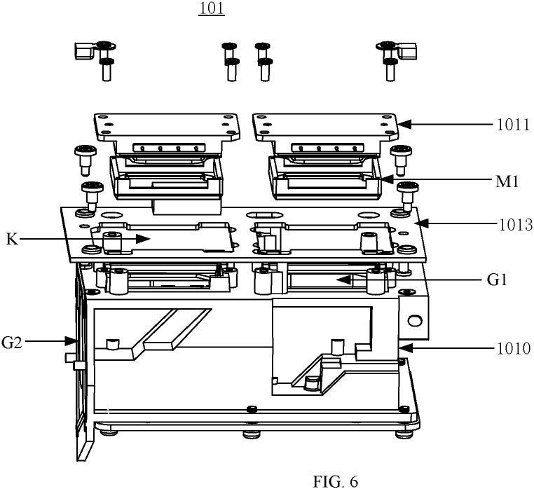

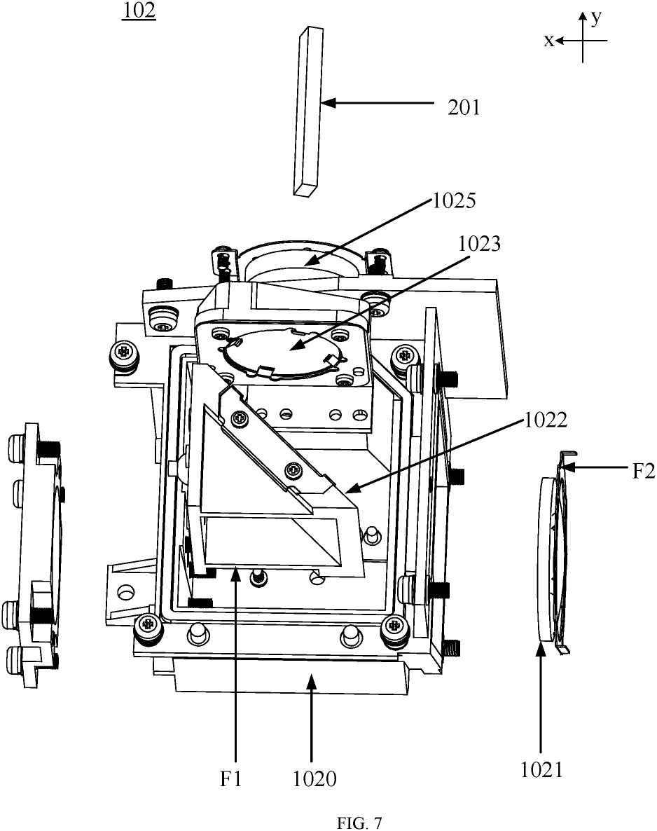

In some embodiments of the disclosure, the first housing 1010, the lasers 1011 and the beam combination mirror groups 1012 constitute a first light source body 101; and the second housing 1020, the convex lens 1021, the reflector 1022, the concave lens 1023, the angle adjustment element 1024 and the converging lens 1025 constitute a second light source body 102. FIG. 5 shows a structural schematic diagram of a first light source body according to some embodiments of the disclosure, FIG. 6 shows another structural schematic diagram of the first light source body according to some embodiments of the disclosure, and FIG. 6 shows a view of the first light source body shown in FIG. 5 after rotating 180 degrees. FIG. 7 shows a structural schematic diagram of a second light source body according to some embodiments of the disclosure, FIG. 8 shows another structural schematic diagram of the second light source body according to some embodiments of the disclosure, and FIG. 8 shows a view of the light source assembly shown in FIG. 7 after rotating 90 degrees.

Referring to FIGS. 2 to 8, each beam combination mirror group 1012 is located at the light-emitting side of the corresponding laser 1011. The plurality of beam combination mirror groups 1012, the convex lens 1021 and the reflector 1022 in the light source assembly 10 are arranged in sequence in the first direction (such as the x direction in the figure). The reflector 1022, the concave lens 1023, the angle adjustment element 1024 and the converging lens 1025 may be arranged in sequence in the third direction (such as the y direction in the figure). In a possible embodiment, the first direction is perpendicular to the third direction. Each beam combination mirror group 1012 is configured to cause the laser light emitted by the corresponding laser 1011 transmit to the convex lens 1021. The convex lens 1021 is configured to emit the incident laser light to the reflector 1022, and the reflector 1022 is configured to reflect the incident laser light, so that the laser light is emitted to the light modulation assembly after passing through the concave lens 1023, the angle adjustment element 1024 and the converging lens 1025 in sequence. The convex lens 1021 and the concave lens 1023 in the second light source body 102 form a beam reducing element, and the laser beam passing through the beam reducing element becomes thinner. In some embodiments of the disclosure, the spot size formed on the convex lens by the laser light emitted from the beam combination mirror group in the first light source body 101 is larger than the spot size formed on the concave lens 1023 by the laser light exiting from the concave lens 1023. In a possible embodiment, the light modulation assembly includes a light pipe configured to receive the laser light emitted by the light source assembly toward the optical engine.

In some embodiments of the disclosure, the laser light emitted by each beam combination mirror group 1012 is directed to different positions of the convex lens 1021, and forms a light spot on the convex lens 1021. A plurality of light spots formed by the laser light emitted by the plurality of beam combination mirror groups 1012 on the convex lens 1021 are respectively located on both sides of the plane where the optical axis of the convex lens 1021 is located, thereby ensuring that the laser light emitted by the convex lens is relatively evenly distributed. Thus the uniformity of the laser light emitted by the light source assembly and the better display effect of the projection picture formed by the laser light may be ensured. In a possible embodiment, the difference between the numbers of light spots on both sides of the plane is less than or equal to a number threshold. In a possible embodiment, the number threshold may be 1, so as to ensure that the light spots are distributed as uniformly as possible. In a possible embodiment, the plurality of light spots are also symmetrical about the plane where the optical axis of the convex lens 1021 is located, to further ensure the uniform distribution of the laser light emitted by the convex lens and improve the display effect of the projection picture. It should be noted that the plurality of light spots are located on both sides of the first plane where the optical axis is located, but are symmetrical about the second plane where the optical axis is located, where the first plane is different from the second plane; for example, the number of light spots is an odd number. Alternatively, when the number of light spots is an odd number, the first plane may be the same as the second plane.

In a possible embodiment, the laser light emitted from the convex lens also forms a plurality of light spots on the concave lens and the converging lens, and the optical axes of the concave lens, the converging lens and the light pipe in the light modulation assembly are all collinear. It is necessary to note that the optical axis of the light pipe is also the central axis of the light pipe, the light pipe may be rod-like, and the optical axis of the light pipe is parallel to the length direction thereof. The plurality of light spots on the concave lens and the converging lens are located on both sides of a certain plane where the collinear optical axis are located, and are also symmetrical about the certain plane where the collinear optical axis is located. In a possible embodiment, the plane includes at least one of the meridional plane and the sagittal plane of the light pipe, the sagittal plane and the meridional plane of the light pipe may both pass through the optical axis of the light pipe, and the sagittal plane is perpendicular to the meridional plane. For example, a plurality of light spots formed on the concave lens or the converging lens may be respectively located on both sides of the sagittal plane of the light pipe, or on both sides of the meridional plane of the light pipe, or on both sides of the sagittal plane of the light pipe and both sides of the meridional plane of the light pipe. The plurality of light spots formed on the concave lens or the converging lens may be symmetrical with respect to the sagittal plane of the light pipe, or may be symmetrical with respect to the meridian plane of the light pipe, or may be symmetrical with respect to the meridian plane and the sagittal plane of the light pipe at the same time, which is not limited in the embodiments of the disclosure.

It should be noted that the symmetry of the plurality of light spots with respect to the certain plane includes: the plurality of light spots being absolutely symmetrical with respect to at least one plane, and the situation that the plurality of light spots being approximately symmetrical with respect to at least one plane, which is not limited herein. Two light spots being approximately symmetrical with respect to a plane can be understood as that a difference between the area that is symmetrical to one of the two light spots with respect to the plane and the other light spot is within a set error tolerance. For example, the positional difference or dimensional difference between the area and the other light spot is within the error tolerance.

In a possible embodiment, the plurality of lasers in the light source assembly all emit light in the same direction. For example, as shown in FIG. 4, in some embodiments of the disclosure, the light source assembly includes two lasers 1011 that are arranged in the x-direction, and both the two lasers emit light in the same direction (such as the y direction in FIG. 4) as an example for illustration. In a possible embodiment, the light-emitting directions of the lasers may also be different. For example, the two lasers may also be arranged in the y direction, and one of the two lasers emits light in the y direction, and the other laser emits light in the opposite direction of the y direction. In some embodiments of the disclosure, the arrangement of the lasers in the light source assembly is not limited. It is merely necessary to ensure that the plurality of light spots formed by the laser light emitted by the plurality of lasers on the convex lens meet the requirement on the light spot distribution in the embodiments of the disclosure. For example, it is necessary to ensure that the plurality of light spots are symmetrical with respect to the plane where the optical axis of the convex lens is located.

In one possible embodiment, each laser emits laser light of at least two colors. For example, each laser may include a plurality of light-emitting areas, each light-emitting area may be used to emit laser light of one color, the colors of laser light emitted by different light-emitting areas may be different, and the plurality of light-emitting areas may be sequentially arranged in a certain direction. For example, in some embodiments of the disclosure, the plurality of light-emitting areas in the laser of the light source assembly may be sequentially arranged according to the arrangement direction (that is, the x-direction) of the laser and the convex lens. The plurality of light-emitting areas may include a first light-emitting area and a second light-emitting area. The divergence angle of the laser light emitted by the first light-emitting area is greater than the divergence angle of the laser light emitted by the second light-emitting area. The first light-emitting area may be closer to the convex lens than the second light-emitting area. For example, the first light-emitting area may emit the red laser light, and the second light-emitting area may emit the blue laser light and the green laser light. Since the laser light has a certain divergence angle, the larger the divergence angle of the laser light is, the larger the formed light spot is; and the longer the transmission optical distance of the laser light travels, the larger the formed light spot is. In some embodiments of the disclosure, the first light-emitting area of the laser is closer to the convex lens than the second light-emitting area. As such, the transmission optical distance of the laser light emitted by the first light-emitting area is shorter than the transmission optical distance of the laser light emitted by the second light-emitting area when being emitted to the convex lens. Therefore the size of the light spot formed by the laser light emitted from the first light-emitting area on the convex lens may be relatively small. Also, the difference between the size of this light spot and the size of the light spot formed by the laser light emitted from the second light-emitting area on the convex lens may be relatively small. In this way, it can be ensured that the size of the light spot formed on the convex lens by the laser light emitted after mixture and reflection by the beam combination mirror group, so the size of the convex lens may be relatively small.

In some embodiments of the disclosure, the laser may include at least two types of light-emitting chips, different types of light-emitting chips are used to emit laser light of different colors, and the area where each type of light-emitting chip is located may be a light-emitting area in the laser. In some embodiments of the disclosure, the laser may be a Multi-chip Laser Diode (MCL)-type laser. The MCL-type laser may include a plurality of light-emitting chips arranged in multiple rows and columns, and a plurality of collimating lenses in one-to-one correspondence to the plurality of light-emitting chips, where the plurality of collimating lenses may also be arranged in multiple rows and columns. The laser light emitted by each light-emitting chip may be directed to the corresponding collimating lens, and then is collimated by the collimating lens before being emitted from the laser.

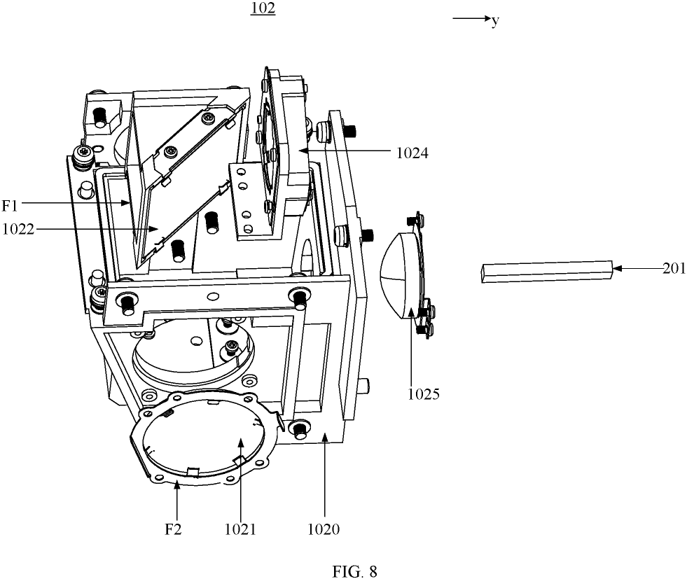

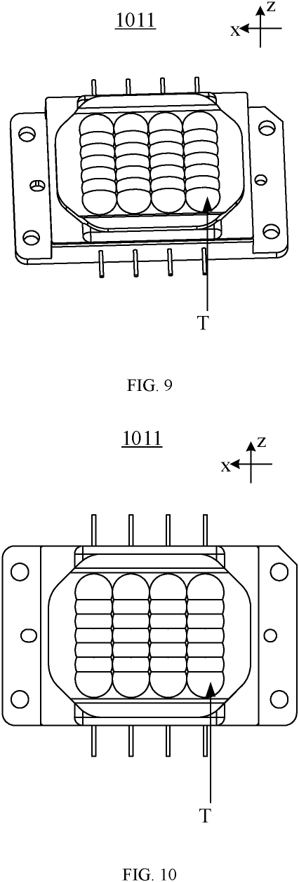

For example, FIG. 9 shows a structural schematic diagram of a laser according to some embodiments of the disclosure, FIG. 10 shows another structural schematic diagram of the laser according to some embodiments of the disclosure, and FIG. 10 may be a top view of the laser shown in FIG. 9. As shown in FIGS. 9 and 10, the laser 1011 may include a plurality of collimating lenses T arranged in seven rows and four columns, and a plurality of light-emitting chips arranged in seven rows and four columns in one-to-one correspondence to the plurality of collimating lenses T (not shown in the figure). Here each collimating lens T corresponds to one light-emitting chip. In the first direction (such as the x direction) in FIGS. 9 and 10, the first column of light-emitting chips in the laser are configured to emit green laser light, the second column of light-emitting chips are configured to emit blue laser light, the third and fourth columns of light-emitting chips are configured to emit red laser light. In the laser, the area where the first column of light-emitting chips are located may be one light-emitting area, the area where the second column of light-emitting chips are located may be another light-emitting area, and both of these two light-emitting areas may be the above-mentioned second light-emitting areas. The area where the third and fourth columns of light-emitting chips are located may be yet another light-emitting area, which may be the above-mentioned first light-emitting area.

In some embodiments, as shown in FIG. 2, FIG. 4 and FIG. 6, the beam combination mirror group 1012 corresponding to each laser 1011 includes a plurality of beam combination mirrors J. Each beam combination mirror J corresponds to one light-emitting area in the laser 1011 and is configured to reflect the laser light emitted from the light-emitting area. The plurality of beam combination mirrors J may be arranged in sequence in the arrangement direction (such as the x direction in FIG. 4) of the light-emitting areas in the laser 1011. The plurality of beam combination mirrors J in each beam combination mirror group 1012 may be all inclined relative to the light-emitting surface of the laser 1011 (that is, the included angle between the beam combination mirror and the light-emitting surface is an acute angle or an obtuse angle). The plurality of beam combination mirrors J may reflect the incident laser light toward the target direction, which may be parallel to the arrangement direction of the plurality of beam combination mirrors J, for example, the target direction may be the x direction. In this way, some beam combination mirrors in the beam combination mirror group 1012 reflect the laser light to other beam combination mirrors. The other beam combination mirrors may be dichroic mirrors, and configured to reflect the laser light emitted from the corresponding light-emitting areas and transmit the laser light emitted from other light-emitting areas. For example, the beam combination mirror corresponding to the light-emitting area that emits the red laser light may reflect the red laser light, and transmit the blue laser light and the green laser light. As such, the laser light emitted by the beam combination mirror group 1012 may be the laser light obtained after mixing the laser light reflected by the beam combination mirrors, and the beam combination mirror group 1012 has the effect of mixing the laser light emitted by the corresponding laser 101. For example, the light emitted by the beam combination mirror group 1012 may be white light obtained by mixing the red laser light, green laser light and blue laser light.

It should be noted that the beam combination mirror group is configured to reflect the incident laser light. The laser light will diverge to a certain extent in the propagation process, while the laser light emitted by each beam combination mirror group needs to be directed to a different position of the convex lens. As such, the distance between the beam combination mirror groups may satisfy a certain condition, to ensure that the laser light emitted by each beam combination mirror group can all be directed to the convex lens and will not be directed to other beam combination mirror groups and be reflected outside the convex lens. In some embodiments, as shown in FIGS. 2-7, the light source assembly includes two lasers and two beam combination mirror groups, and the two lasers are arranged in the x direction and have the same light-emitting direction. The condition that the two beam combination mirror groups satisfy may be: the distance range between the two beam combination mirror groups is 11 mm to 13 mm in the light-emitting direction (i.e., the y direction) of any laser. For example, the distance between the two beam combination mirror groups may be 12 mm in the y direction. It should be noted that the distance between the two beam combination mirror groups in the y direction is also the distance between two beam combination mirrors closest to each other in the y direction in the two beam combination mirror groups. The minimum gap between the beam edge of the laser light reflected by the first beam combination mirror group far away from the convex lens in the x direction and the second beam combination mirror group close to the convex lens is about 0.5 mm. As such, the second beam combination mirror group will not block the laser light reflected by the first beam combination mirror group, and the distance between the laser beams reflected by the two beam combination mirror groups will not be too large. In this way, the distance between two light spots formed by the laser light reflected by the two beam combination mirror groups on the convex lens is relatively small, accordingly the convex lens of a small size can be enough to realize the collection of the laser light emitted by the two beam combination mirror groups, thereby reducing the size of the light source assembly as a whole. In a possible embodiment, for the case where the light-emitting directions of the two lasers are parallel, such as the case where the light-emitting directions of the two lasers are opposite, the two beam combination mirror groups may also satisfy the above condition. It should be noted that, for other numbers of lasers and beam combination mirror groups as well as other setting relationships between lasers and beam combination mirror groups, two beam combination mirror groups that may have mutual influence can satisfy the above condition, which is not limited in the embodiments of the disclosure.

Continuing to refer to FIG. 6, in some embodiments of the disclosure, the first light source body 101 further includes a Printed Circuit Board (PCB) 1013, through which the plurality of lasers 1011 in the first light source body 101 are connected with the power supply. The lasers 1011, in response to the current provided by the power supply through the printed circuit board 1013, emit the laser light under the excitation of the current. The printed circuit board 1013 may have a plurality of hollow areas K in one-to-one correspondence to the plurality of lasers 1011, and each laser 1011 is disposed in the corresponding hollow area K. Each laser 1011 can pass through the corresponding hollow area K, and the pins of the laser 1011 are fixed to the peripheral area of the hollow area K in the printed circuit board 1013. The peripheral area may be provided with wires connected with the power supply, and the pins of the laser 1011 are connected with the power supply through the connected wires. In some embodiments of the disclosure, the plurality of lasers are connected with the power supply through the same printed circuit board, thereby reducing the size of the printed circuit board. It is not necessary to design a separate printed circuit board for each laser for assembly, so the design and assembly process of the light source assembly can be simplified.

Exemplarily, continuing to refer to 6, the first light source body 101 includes two lasers 1011, and the printed circuit board 1013 has two hollow areas K in one-to-one correspondence to the two lasers 1011, and a wiring area (not marked in the figure) between the two hollow areas K. In a possible embodiment, the width of the wiring area in the arrangement direction of the two hollow areas ranges from 4.5 mm to 6.5 mm, for example, the width may be 5.5 mm. For example, the wire width set in the wiring area may be 3.5 mm, and a blank area with 1 mm width may be reserved between both sides of the wire and the hollow area. It should be noted that it is necessary to ensure that the distance between the lasers is as small as possible in order to make the structures in the light source assembly more compact, but it is more difficult to arrange the wires on the printed circuit board if two lasers are directly next to each other. Also, in order to ensure the normal power supply of each laser, the wires occupy a large area on the printed circuit board, thus causing the size of the printed circuit board to become larger. In some embodiments of the disclosure, there is a non-hollow wiring area between the hollow areas corresponding to two lasers in the printed circuit board. The certain wiring may be performed in the wiring area, which can reduce the wiring difficulty of the printed circuit board and can correspondingly reduce the wiring area of the wires in the peripheral area of the printed circuit board, and can reduce the volume of the printed circuit board as a whole. Also, the width of the wiring area is relatively small, so the spacing of the lasers is relatively small, the arrangement of the lasers is relatively compact, and the volume of the first light source body can be relatively small.

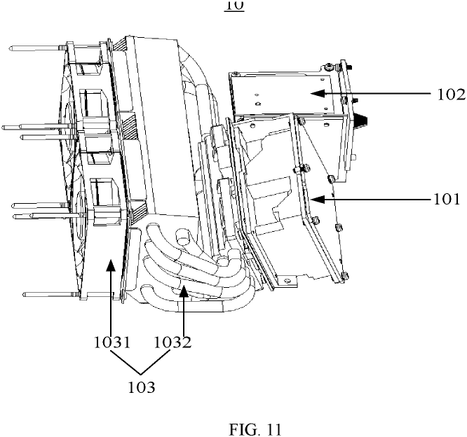

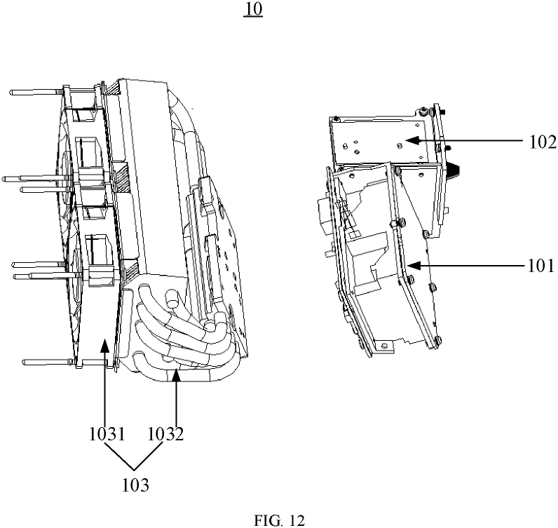

In a possible embodiment, FIG. 11 shows a structural schematic diagram of yet another light source assembly according to some embodiments of the disclosure, FIG. 12 shows another structural schematic diagram of the light source assembly according to some embodiments of the disclosure, and FIG. 12 be an explosive view of the light source assembly shown in FIG. 11. As shown in FIGS. 11 and 12, the light source assembly 10 may further include a heat dissipation unit 103, which may include a heat dissipation fan 1031 and a heat pipe 1032. The heat dissipation fan 1031 is connected with the first light source body (such as the laser in the first light source body) through the heat pipe 1032, to assist in dissipating the heat generated by the laser, avoid the damage to the laser caused by the heat accumulation, and improve the life and luminous efficiency of the laser.

In some embodiments of the disclosure, the light source assembly includes a plurality of lasers, such as two lasers, so that the brightness of the laser light emitted by the light source assembly is relatively high. For example, the luminous flux output by the light source assembly is about 10,000 lumens, and the luminous flux output after passing through the light modulation assembly and the lenses is greater than 3000 lumens. The two lasers may directly emit red laser light, green laser light and blue laser light, instead of using the laser light of one color to excite the laser light of other colors through fluorescent materials, so the laser light of each color output by the lasers has a wider color gamut. In this way, the projection image obtained according to the laser light output by the light source assembly provided by some embodiments of the disclosure has a higher brightness and a wider color gamut, and a better display effect.

The manner to fix the components in the first light source body will be introduced below.

Continuing to refer to FIGS. 5 and 6, the first housing may be approximately square, the first housing may be surrounded by six walls, and each wall in the first housing may be flat or uneven or in other shape, which is not limited in the embodiments of the disclosure. The plurality of light inlets in the first housing may be located in the first wall of the first housing, the light outlet of the first housing may be located in the second wall of the first housing, and the first wall may be perpendicular to the second wall. That is, the first wall of the first housing has a plurality of hollow areas serving as the plurality of light inlets, and the second wall of the first housing has a hollow area serving as the light outlet. In some embodiments of the disclosure, the side of the first housing where the light inlets are located is the first wall, and the side where the light outlet is located is the second wall.

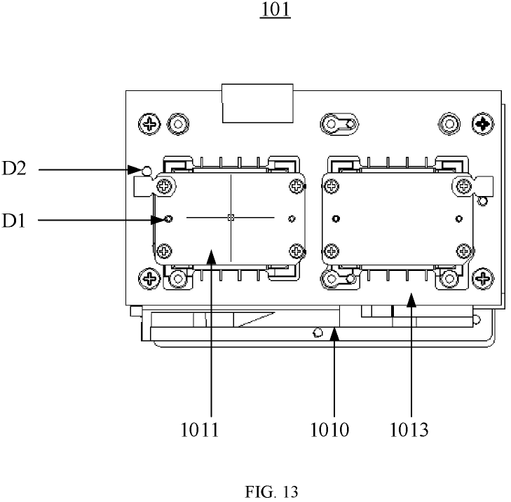

FIG. 13 shows yet another structural schematic diagram of a first light source body according to some embodiments of the disclosure, and FIG. 13 may be a top view of FIG. 6. Continuing to refer to FIGS. 6 and 13, in the first light source body 101, a bottom plate of the lasers 1011 is connected with the portion where the light inlets of the first housing 1010 are located through a screw. Exemplarily, the bottom plate of the lasers has a plurality of third mounting holes, and the portion where the light inlets of the first housing are located has a plurality of fourth mounting holes in one-to-one correspondence to the plurality of third mounting holes. Each fourth mounting hole may have threads in its inside wall, and the screws may extend through the third mounting holes into the corresponding fourth mounting holes to thereby lock the lasers and the first housing. In a possible embodiment, continuing to refer to FIG. 6 and FIG. 13, in the first light source body, the printed circuit board is also connected with the portion where the light inlets of the first housing are located through a screw. Exemplarily, the printed circuit board has a plurality of fifth mounting holes, and the portion where the light inlets of the first housing are located further has a plurality of sixth mounting holes in one-to-one correspondence to the plurality of fifth mounting holes. Each sixth mounting hole may have threads in its inside wall, and the screws may extend through the fifth mounting holes into the corresponding sixth mounting holes to thereby lock the printed circuit board and the first housing. It should be noted that the lasers and the printed circuit board are both connected with the portion where the light inlets of the first housing are located through screws in some embodiments of the disclosure, so that the stability of the arrangement of the printed circuit board and the lasers can be improved. Since the lasers and the printed circuit board are fixed, it is also possible to only fix the lasers to the first housing through screws or only fix the printed circuit board to the first housing through screws, which is not limited in the embodiments of the disclosure. It should be noted that the mounting holes in the light source assembly are not marked in some embodiments of the disclosure.

In some embodiments of the disclosure, the bottom plate of the lasers may have a plurality of positioning holes (such as the positioning holes D1 in FIG. 13), and the portion where the light inlets of the first housing are located may have a plurality of locating pins in one-to-one correspondence to the plurality of positioning holes D1. When fixing the lasers and the first housing, the locating pins in the first housing may be firstly inserted into the positioning holes in the lasers corresponding to the locating pins to preliminarily define the relative positions of the first housing and the lasers, then the first housing and the lasers are locked by screws. As such, the assembly of the lasers in the first housing can be completed. The printed circuit board may also have a plurality of positioning holes (such as the positioning holes D2 in FIG. 13), and the portion where the light inlets of the first housing are located may further have a plurality of locating pins in one-to-one correspondence to the plurality of positioning holes D2. When fixing the printed circuit board and the first housing, firstly the locating pins of the first housing corresponding to the printed circuit board may be inserted into the corresponding positioning holes in the printed circuit board to preliminarily define the relative positions of the first housing and the printed circuit board, and then the first housing and the printed circuit board may be locked by screws. As such, the fixation of the printed circuit board in the first housing can be completed. In some embodiments of the disclosure, the locating pins of the first housing are inserted into the positioning holes on the lasers and the printed circuit board, so that the laser light emitted by the laser can be accurately emitted to the beam combination mirror group corresponding to the laser in the first housing. Further, the case where the laser light emitted by the laser cannot be accurately emitted to the beam combination mirror group due to the large installation tolerance when only the third mounting hole in the laser and the fourth mounting hole in the first housing are fixed by a screw, can be avoided.

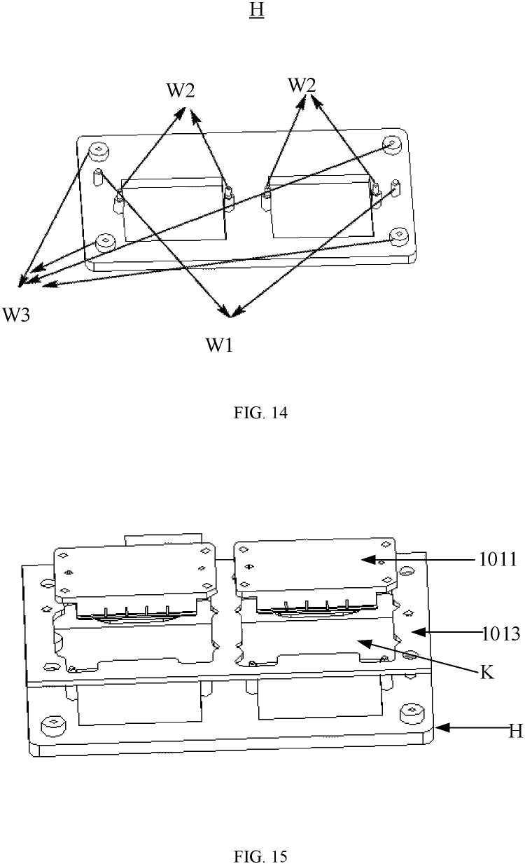

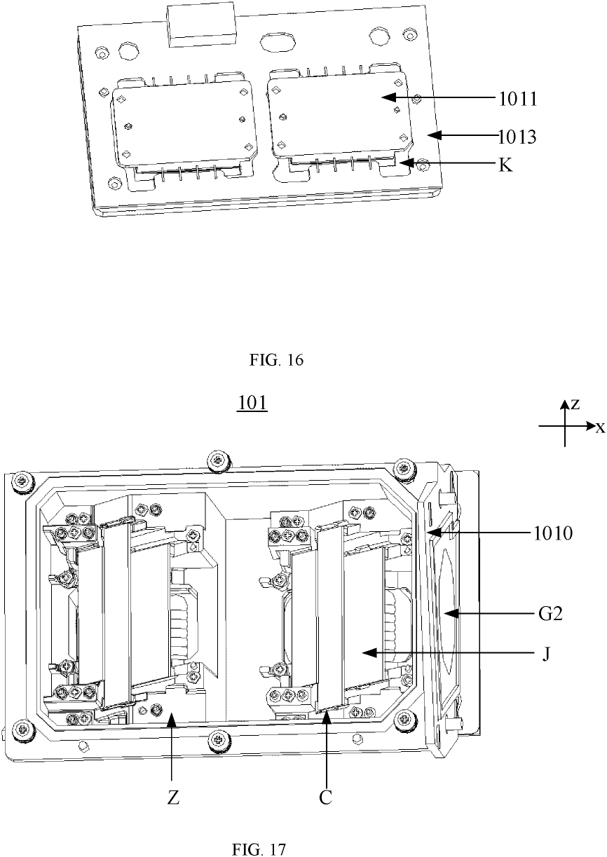

In some embodiments of the disclosure, the lasers and the printed circuit board may be fixed together at first, and then the fixed lasers and printed circuit board may be fixed in the first housing. Exemplarily, the lasers and the printed circuit board may be assembled based on a welding fixture H shown in FIG. 14. The welding fixture has key features related to the fixation of the lasers and the printed circuit board in the first housing. For example, the welding fixture includes laser locating pins W1, circuit board locating pins W2, and circuit board support tables W3. When the lasers and the printed circuit board are assembled, the positioning holes in the printed circuit board may be firstly aligned with the circuit board locating pins on the welding fixture to insert the locating pins into the corresponding positioning holes, and then the printed circuit board is supported against the support tables on the welding fixture. Next, as shown in FIG. 15, the positioning holes in two lasers may be respectively aligned with the corresponding locating pins of the welding fixture. Each locating pin is inserted into the corresponding positioning hole in the laser under the action of gravity, and the pins in the lasers may lap on the printed circuit board, thereby ensuring the good contact between the laser pins and the printed circuit board. Finally, the solder or other welding materials can be used to weld the pins of the lasers to the printed circuit board to form the structure shown in FIG. 16. After that, the welding fixture can be removed, and the fixed structure of the lasers and the printed circuit board is fixed to the first housing.

In a possible embodiment, continuing to refer to FIG. 6, the first light source body further includes: a first sealing ring M1 that may be configured to seal the laser 1011 and a peripheral area of the corresponding light inlet G1. Exemplarily, the first sealing ring M1 may be a sealing rubber ring. The first sealing ring M1 may be disposed between the laser 1011 and the peripheral area of the light inlet G1 in the first wall of the first housing 1010, and closely contact the edge area of the tube housing in the laser 1011 and the peripheral area of the light inlet G1 in the first wall of the first housing 1010 to seal the laser 1011 and the peripheral area of the corresponding light inlet G1. Thus, light emitting effect of the laser will not be affected by dust attached to the light-emitting surface of the laser by passing through the gap between the laser and the first housing. For example, before fixing the laser to the first housing, the first sealing ring may be firstly placed on the side of the light inlet of the first housing. Then the laser and the first housing may squeeze the first sealing ring when fixing the laser and the first housing by screws, so that the first sealing ring is in close contact with the laser and the first wall of the first housing.

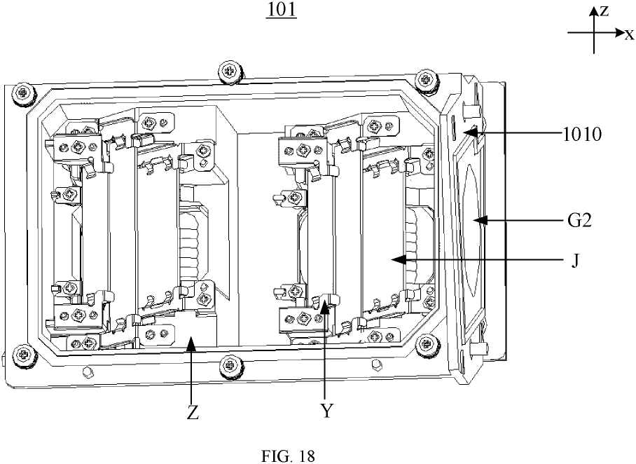

As shown in FIGS. 17 and 18, the plurality of beam combination mirror groups in the first housing include a plurality of beam combination mirrors J arranged in the first direction (e.g., the x direction), which may be parallel to the arrangement direction of the first housing and the second housing. There are a plurality of groups of mirror slots C and a plurality of groups of spring contacts Y inside the first housing, and the plurality of groups of mirror slots C and the plurality of groups of spring contacts Y are both in one-to-one correspondence to the beam combination mirrors J in the light source assembly. That is, each beam combination mirror J corresponds to a group of mirror slots C and a group of spring contacts Y Two ends of each beam combination mirror J in the second direction (such as the z direction in the figure) are respectively located in a corresponding group of mirror slots, and the first direction is perpendicular to the third direction. Each group of spring contacts Y are located on one side of the corresponding beam combination mirror J away from the light inlets of the first housing 1010, and configured for pressing the surface of the beam combination mirror J away from the light inlets of the first housing 1010 and one end of the beam combination mirror J close to the light outlet G2 of the first housing 1010 in the first direction.

Exemplarily, each group of mirror slots C includes two mirror slots C, which are respectively located in two inner walls of the first housing 1010 that are opposite to each other in the third direction, and each mirror slot C is of a long strip shape inclined towards the light outlet G2 of the first housing 1010. One end of each mirror slot C close to the light inlet of the first housing 1010 is closed, and one end close to the light outlet of the first housing 1010 is open. Two ends of the beam combination mirror J in the third direction may be snapped into a corresponding group of mirror slots C through one end of the mirror slot C close to the light outlet of the first housing 1010. The inner wall of the first housing 1010 has a mounting stand Z. Each group of spring contacts include two spring contacts Y Each spring contact Y has a mounting hole, and is fixed on the corresponding mounting stand Z, to thereby press the corresponding beam combination mirror J. In some embodiments, each spring contact Y may have a plurality of presser feet. Some of the presser feet are in contact with the surface of the beam combination mirror J away from the light inlets of the first housing 1010 to apply pressure to this surface, and the rest of the presser feet are in contact with the end of the beam combination mirror Y close to the light outlet of the first housing 1010 in the first direction (e.g., the lateral surface of the beam combination mirror close to the light outlet) to apply pressure to this lateral surface, thereby realizing the fixation of the beam combination mirror. It should be noted that the beam combination mirror is in the shape of a plate, and the beam combination mirror has two opposite and parallel larger plate surfaces, and a smaller lateral surface connecting the two surfaces. In some embodiments of the disclosure, the surface far away from the first housing and the surface close to the first housing in the beam combination mirror are the two plate surfaces of the beam combination mirror. The surface of one end of the beam combination mirror close to the light outlet in the first direction is one lateral surface of the beam combination mirror.

In some embodiments of the disclosure, the walls of the first housing may be integrally formed or may be assembled from independent structures, or some of the walls may be integrally formed and some of the walls may be independent, which is not limited in the embodiments of the disclosure. Exemplarily, as shown in FIG. 6, the third wall B opposite to the first wall in the first housing 1010 of the first light source body may be of a plate-like structure independent from other walls in the first housing. The third wall B may have a plurality of mounting holes, and the third wall B may be fixed on other walls of the first housing 1010 by screws.

The manner to fix the components in the second light source body will be introduced below.

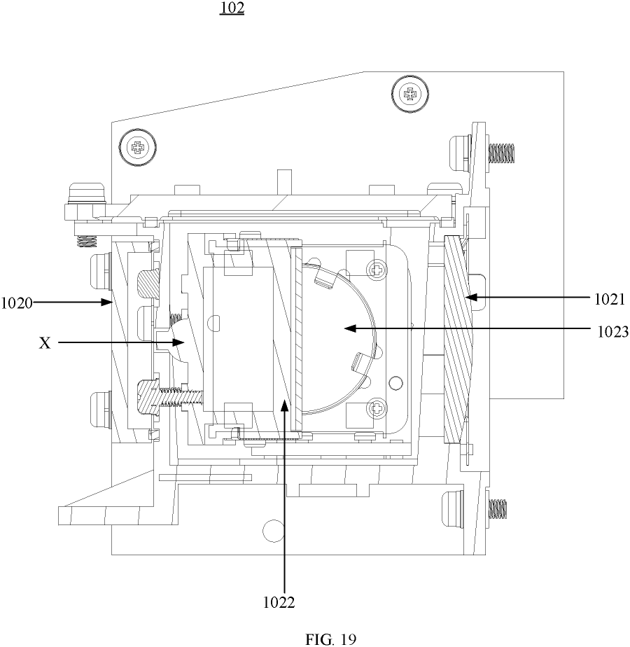

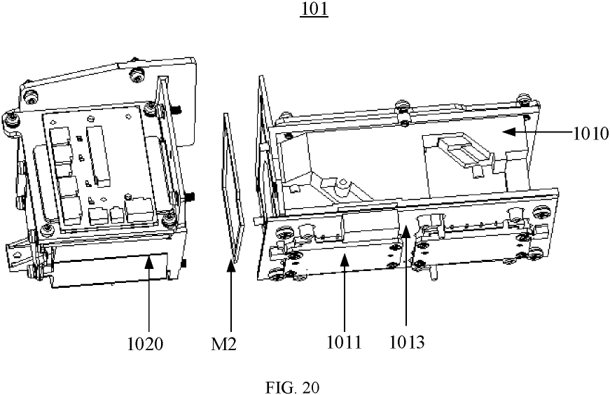

FIG. 19 shows yet another structural schematic diagram of a second light source body according to some embodiments of the disclosure. FIG. 19 may be a bottom view of the second light source body shown in FIG. 7, and may be a right view of the second light source body shown in FIG. 8. Referring to FIG. 7, FIG. 8 and FIG. 19, the second light source body 102 may further include a second housing 1020 having a light inlet and a light outlet. The light outlet G2 of the first housing 1010 is connected with the light inlet of the second housing 1020; the reflector 1022, the concave lens 1023 and the angle adjustment element 1024 are disposed in the second housing 1020; and the converging lens 1025 is disposed at the light outlet of the second housing 1020. The second housing may be approximately square, and the second housing 1020 may be surrounded by six walls. Each wall in the second housing may be flat or uneven or in other shape, which is not limited in the embodiments of the disclosure. The light inlet in the second housing may be disposed in the first wall of the second housing, the light outlet of the second housing may be disposed in the second wall of the second housing, and the first wall may be perpendicular to the second wall. That is, the first wall of the second housing has a hollow area serving as the light inlet of the second housing, and the second wall of the second housing has a hollow area serving as the light outlet of the second housing. In some embodiments of the disclosure, the portion of the second housing where the light inlet is located is the first wall of the second housing, and the portion of the second housing where the light outlet is located is the second wall of the second housing.

In some embodiments of the disclosure, continuing to refer to FIG. 7, FIG. 8 and FIG. 19, the second housing 1020 of the second light source body 102 is provided with a reflector support F1, which is triangular. The part where one side of the triangle is located in the reflector support F1 is fixed on an inner wall of the second housing, the reflector 1022 is clamped to the part where another side of the triangle is located in the reflector support F1, and the angle formed by the one side and the another side is an acute angle. Exemplarily, the part where one side is located in the reflector support may be fixed on the inner wall of the second housing by a plurality of screws. The second light source body further includes a reflector spring contact (not shown in the figure). The reflector spring contact is fixed on the side of the reflector support by screws, and the presser feet of the reflector spring contact are in contact with the edge of the reflector to thereby press the reflector and fix the reflector on the reflector support. In some embodiments of the disclosure, when the reflector support and the second housing are preliminarily fixed, the reflector support can perform the slight angular adjustment. For example, the reflector support may further include an angle regulation element X, of which one end may be snapped into an accommodating slot (not shown in the figure) of the inner wall of the second housing, and the angle regulation element may move appropriately in the accommodating slot. In some embodiments of the disclosure, the reflector may be fixed on the reflector support at first, and then the reflector support with the reflector fixed is fixed in the second housing. The arrangement angle of the reflector support may be finetuned by the angle regulation element to ensure that the laser light reflected by the reflector can be accurately emitted from the light outlet of the second housing, and then the screws used to fix the reflector support are tightened to complete the fixation of the reflector support and the second housing.

In some embodiments of the disclosure, the second light source body further includes: at least one annular bracket F2 fixed in the second housing. The at least one annular bracket F2 is in one-to-one correspondence to at least one of the convex lens, the concave lens and the converging lens, and each of the at least one lens is clamped to the corresponding annular bracket F2 and covers a hollow area in the middle of the annular bracket. Exemplarily, continuing to refer to FIG. 7, FIG. 8 and FIG. 19, each of the convex lens 1021, the concave lens 1023 and the converging lens 1025 is fixed in the second housing 1020 through an annular bracket F2, and the annular bracket F2 may be fixedly connected with the second housing 1020 by screws. In a possible embodiment, the angle adjustment element 1024 and the concave lens 1023 may be fixed on two sides of the same annular bracket F2. The convex lens 1021 may be fixed on the first wall of the second housing through the corresponding annular bracket F2, and located outside the accommodating space of the second housing. The angle adjustment element 1024 and the concave lens 1023 may be fixed on the second wall of the second housing through the corresponding annular brackets F2, and located in the accommodating space of the second housing. The converging lens 1025 may be fixed on the second wall of the second housing through the corresponding annular bracket F2, and located outside the accommodation space of the second housing.

The manners to fix the first light source body and the second light source body will be introduced below.

In a possible embodiment, the portion where the light outlet of the first housing in the first light source body is located is connected with the portion where the light inlet of the second housing in the second light source body is located through a screw. FIG. 20 shows a structural schematic diagram of still another light source assembly according to some embodiments of the disclosure. As shown in FIG. 20, the side where the light outlet of the first housing 1010 is located has a plurality of first mounting holes, and the side where the light inlet of the second housing 1020 is located has a plurality of second mounting holes in one-to-one correspondence to the plurality of first mounting holes. Each second mounting hole may have threads on its inside wall, and the screws may extend through the first mounting holes into the corresponding second mounting holes, thereby locking the first light source body and the second light source body. In a possible embodiment, one of the portion where the light outlet of the first housing is located and the portion where the light inlet of the second housing is located has a locating pin, and the other has a positioning hole corresponding to the locating pin. The first housing and the second housing are fixedly connected by protruding the locating pin into the corresponding positioning hole. In FIG. 20, the portion where the light outlet of the first housing 1010 is located has a locating pin, and the portion where the light inlet of the second housing 1020 is located has a positioning hole, as an example for illustration. In a possible embodiment, the second housing may have a locating pin and the first housing may have a positioning hole, or each of the first housing and the second housing has a locating pin and a positioning hole, which is not limited in the embodiments of the disclosure. Exemplarily, when mounting the first light source body and the second light source body, the locating pin in the first housing of the first light source body may be firstly inserted into the positioning hole corresponding to the locating pin in the second housing of the second light source body, to preliminarily define the relative positions of the first light source body and the second light source body. Then the first light source body and the second light source body are locked by screws, so that the assembly of the first light source body and the second light source body can be completed.

In a possible embodiment, as shown in FIG. 20, the light source assembly further includes: a second sealing ring M2 configured to seal a peripheral area of the light outlet of the first housing 1010 and a peripheral area of the light inlet of the second housing 1020. Exemplarily, the second sealing ring may be a sealing rubber ring. The second sealing ring may be located between the second wall of the first housing and the first wall of the second housing, closely contact the second wall of the first housing and the first wall of the second housing, and surround the light outlet of the first housing and the light inlet of the second housing, to seal the joint between the first housing and the second housing, thereby avoiding a problem that light emitting effect of the light source assembly is affected due to dust from passing through the gap between the first housing and the second housing to attach to the optical elements in the first housing and the second housing. For example, before fixing the first housing and the second housing, the second sealing ring is firstly placed between the first housing and the first housing, and then the locating pins in the first housing and the second housing are inserted into the corresponding positioning holes, and the screws for fixing the first housing and the second housing are tightened. In this way, the first housing and the second housing can be used for pressing the second sealing ring to ensure that the second sealing ring is in close contact with the first housing and the second housing.

To sum up, the light source assembly provided by some embodiments of the disclosure includes a plurality of lasers, so that the brightness of the laser light emitted by the light source assembly can be higher, and the display effect of the projection picture formed based on the laser light is better. In addition, the elements in the light source assembly may be fixed to the two housings, so there are fewer elements fixed in each housing, and the assembly of the light source assembly is less difficult. The laser light emitted by the convex lens may be reflected by the reflector and then emitted to the concave lens and the converging lens, as such, the transmission optical path of the laser light in the light source assembly is bent. The optical devices in the light source assembly and the light modulation assembly can be arranged in two directions, and the overall device arrangement of the light source assembly and the light modulation assembly is relatively compact, so the volume of the projector where the light source assembly is located can be relatively small.

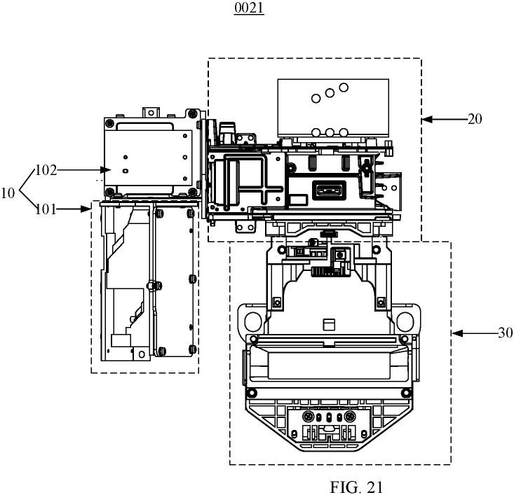

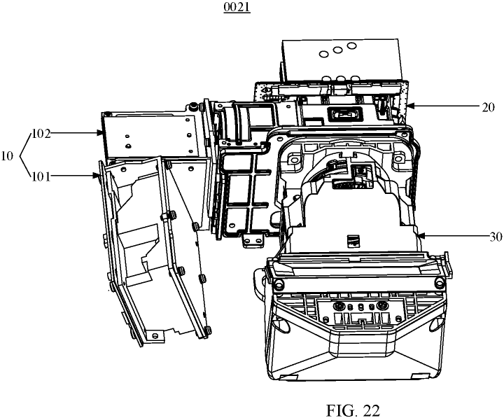

FIG. 21 shows a structural schematic diagram of an optical engine according to some embodiments of the disclosure, FIG. 22 shows another structural schematic diagram of an optical engine according to some embodiments of the disclosure, and FIG. 21 may be a top view of the optical engine shown in FIG. 22. As shown in FIGS. 21 and 22, the optical engine 0021 may include a light source assembly 10, a light modulation assembly 20 and a lens 30. The light source assembly 10 may be any light source assembly 10 described above. The light source assembly 10 includes a first light source body 102 and a second light source body 103. The second light source body 102 and the lens 30 are respectively connected with opposite ends of the light modulation assembly 20, and the first light source body 101 and the lens 30 are located on the same side of the light modulation assembly 20.

The first light source body 101 is configured to emit laser light to the second light source body 102. The second light source body 102 is configured to emit the laser light emitted by the first light source body 101 to the optical engine 20. The optical engine 20 is configured to modulate the incident laser light and then emit it to the lens 30. The lens 30 is configured to project the incident laser light to form a projection picture.

In the embodiments of the disclosure, the light source assembly realizes the turning of the optical path through the reflector, to ensure that various elements in the light source assembly and the light modulation assembly can be arranged in two directions. Thus the first light source body of the light source assembly and the lens can be located on the same side of the light modulation assembly. The optical engine can be U-shaped, to ensure that the components in the optical engine are arranged more compactly and the optical engine occupies a small volume, thereby reducing the volume of the projector.

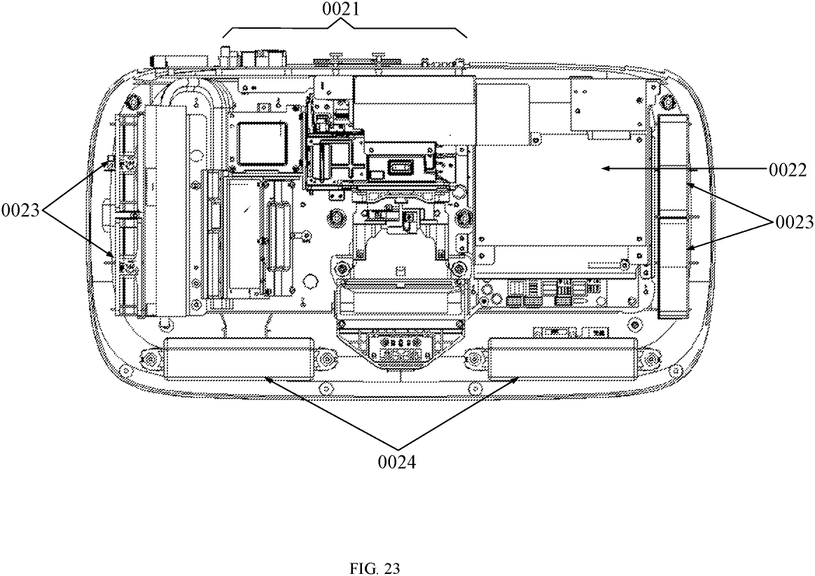

FIG. 23 shows a structural schematic diagram of a projector according to some embodiments of the disclosure. As shown in FIG. 23, the projector includes an optical engine 001, a power supply, a circuit board for display control (the power supply and the circuit board for display control are integrated into a same module 0022 as an example for illustration in the disclosure), and a heat dissipation structure 0023. The optical engine 0021 may be the optical engine including the laser source assembly shown in FIGS. 2 and 3 above.

The heat dissipation structure 0023 may include a heat dissipation fan. In a possible embodiment, the projector may further include at least one sound 0024. The power supply is configured to power the overall system of the projector, for example, power the laser, display panel, fan and sound. The display panel is configured to control signals, for example, control the manner of the light modulation assembly to modulate the laser according to an input image signal. The sound is configured to process and output the sound corresponding to a projection image. The heat dissipation structure is configured to dissipate heat mainly for the overall system of the projector to ensure the stable performance of the system and key components therein. The heat dissipation structure may include a heat dissipation fan connected with the optical engine and another heat dissipation fan located on the side opposite to the heat dissipation fan. The two heat dissipation fans are located at both ends (such as the leftmost and the rightmost) of the projector, and serve as an air inlet and an air outlet respectively, so as to form the convection wind in the projector to cool down various components of the projector.

The term “and/or” in the disclosure is simply an association relationship describing the associated objects, indicating that there may be three relationships, for example, A and/or B may represent: only A, both A and B, and only B. Furthermore, the character “/” herein generally indicates that the associated objects have a kind of “or” relationship. In the disclosure, the term “at least one of A, B and C” means that seven relationships may exist, which may be: A alone exists, B alone exists, C alone exists, A and B exist simultaneously, A and C exist simultaneously, C and B exist simultaneously, and A, B and C exist simultaneously. In the embodiments of the disclosure, the terms “first” and “second” are only for purpose of description, and cannot be construed to indicate or imply the relative importance. The term “a plurality of” refers to two or more, unless otherwise defined explicitly. “Approximately” means an acceptable error range in which those skilled in the art can solve the technical problem and basically achieve the technical effect.

The above description is only the optional embodiments of the disclosure and not intended to limit the disclosure. Any modifications, equivalent replacements, improvements and others made within the spirit and principle of the disclosure are all contained in the protection scope of the disclosure.

What is claimed is:

1. A light source assembly, comprising a first housing, a second housing, a plurality of lasers, a plurality of beam combination mirror groups, a convex lens, a reflector, a concave lens, an angle adjustment element and a converging lens; wherein
the first housing comprises a plurality of light inlets in one-to-one correspondence to the plurality of lasers, and a light outlet;
each of the plurality of lasers is disposed at a corresponding light inlet;
the plurality of beam combination mirror groups are disposed in the first housing;
the second housing comprises a light inlet and a light outlet, and the light outlet of the first housing is connected with the light inlet of the second housing;
the reflector, the concave lens and the angle adjustment element are disposed in the second housing;
the converging lens is disposed at the light outlet of the second housing; wherein
the lasers are configured to emit laser light to the corresponding beam combination mirror groups;
the beam combination mirror groups are configured to mix and reflect the incident laser light to the convex lens;
the convex lens is configured to converge the incident laser light to the reflector; and
the reflector is configured to reflect the incident laser light, so that the laser light is emitted out after passing through the concave lens, the angle adjustment element and the converging lens in sequence.

2. The light source assembly according to claim 1, wherein a portion of the first housing where the light outlet of the first housing is located is connected with a portion of the second housing where the light inlet of the second housing is located through a screw; and/or,
a bottom plate of the lasers is connected with a portion of the first housing where the light inlets of the first housing are located through a screw.

3. The light source assembly according to claim 1, wherein
one of a portion of the first housing where the light outlet of the first housing is located and a portion of the second housing where the light inlet of the second housing is located comprises a locating pin, and the other has a positioning hole corresponding to the locating pin; and
the first housing and the second housing are fixedly connected by protruding the locating pin into the corresponding positioning hole.

4. The light source assembly according to claim 1, wherein a reflector support is provided in the second housing, and the reflector support is triangular;
a part where one side of the triangle is located in the reflector support is fixed on an inner wall of the second housing, the reflector is clamped to a part where another side of the triangle is located in the reflector support, and an angle formed by the one side and the another side is an acute angle.

5. The light source assembly according to claim 1, wherein each of the beam combination mirror groups comprises a plurality of beam combination mirrors arranged in a first direction, the first direction is parallel to an arrangement direction of the first housing and the second housing;
the first housing comprises a plurality of groups of mirror slots and a plurality of groups of spring contacts inside the first housing, and the plurality of groups of mirror slots and the plurality of groups of spring contacts are both in one-to-one correspondence to the beam combination mirrors in the light source assembly;
two ends of each of the beam combination mirrors in a second direction are respectively located in a corresponding group of mirror slots, the first direction is perpendicular to the second direction;
wherein the spring contacts are located on a side of the corresponding beam combination mirror away from the light inlets of the first housing; and
the spring contacts are used for pressing the beam combination mirror away from a portion of the first housing where the light inlets of the first housing are located and an end of the beam combination mirror close to the light outlet of the first housing in the first direction.

6. The light source assembly according to claim 1, wherein the light source assembly further comprises: at least one annular bracket fixed in the second housing;
the at least one annular bracket is in one-to-one correspondence to at least one of the convex lens, the concave lens and the converging lens, and each of the at least one the convex lens, the concave lens and the converging lens is clamped to the corresponding annular bracket and covers a hollow area in middle of the annular bracket.

7. The light source assembly according to claim 1, wherein the light source assembly further comprises: a first sealing ring configured to seal the laser and a peripheral area of the corresponding light inlet; and/or,
the light source assembly further comprises: a second sealing ring configured to seal a peripheral area of the light outlet of the first housing and a peripheral area of the light inlet of the second housing.

8. The light source assembly according to claim 1, wherein the light source assembly further comprises a printed circuit board that has a plurality of hollow areas in one-to-one correspondence to the plurality of lasers;
wherein each of the lasers is configured to run through the corresponding hollow area, pins of the each laser are fixed in a peripheral area of the corresponding hollow area in the printed circuit board, and the each laser is connected with a power supply through the printed circuit board.

9. The light source assembly according to claim 8, wherein the printed circuit board is connected with a portion of the first housing where the light inlets of the first housing are located through a screw.

10. An optical engine, comprising: a light source assembly of claim 1, a light modulation assembly and a lens.

11. A projector, comprising: the optical engine of claim 10, a circuit board of power supply, a circuit board for display control and a heat dissipation structure.

12. A light source assembly, comprising:
a plurality of lasers, wherein at least two of the plurality of lasers are disposed in a portion of a same housing of the light source assembly, and are configured to emit lase light in three colors;
beam combination mirror groups, each for mixing laser light emitted from each of the at least two lasers;
a convex lens and a concave lens;
an angle adjustment element; and
a converging lens; wherein
the beam combination mirror group, the convex lens, the concave lens, the angle adjustment element and the converging lens are disposed in such a way that the laser light from each of the at least two lasers passes through the beam combination mirror group, the convex lens, the concave lens, the angle adjustment element and the converging lens in sequence in that order; and
the laser light emitted from each beam combination group does not overlap with each other and is incident on a position of the convex lens that is different from each other.

13. The light source assembly according to claim 12, further comprising a reflector disposed between the convex lens and the concave lens.

14. The light source assembly according to claim 13, wherein the convex lens, the reflector, the concave lens, the angle adjustment element and the converging lens are disposed in a housing of the light source assembly, which is different from the housing with the lasers.

15. The light source assembly according to claim 12, wherein the laser comprises a plurality of light-emitting areas; and
a first light-emitting area among the plurality of light-emitting areas is configured to emit red laser light, and the first light-emitting area is close to the convex lens.

16. The light source assembly according to claim 12, wherein
the laser light emitted from each beam combination mirror group forms a light spot on the convex lens; and a plurality of light spots formed by the laser light emitted by the beam combination mirror groups on the convex lens are respectively located on both sides of a plane where an optical axis of the convex lens is located; or
laser light emitted from the convex lens forms a plurality of light spots on the concave lens and the converging lens; and
the plurality of light spots formed on the concave lens or the converging lens is symmetrical with respect to a sagittal plane of a light pipe of a light modulation assembly; or
the plurality of light spots formed on the concave lens or the converging lens is symmetrical with respect to a meridian plane of a light pipe of a light modulation assembly; or
the plurality of light spots formed on the concave lens or the converging lens is symmetrical with respect to a meridian plane and a sagittal plane of a light pipe of a light modulation assembly simultaneously.

17. The light source assembly according to claim 12, wherein
the angle adjustment element is one of a diffusion sheet, a fly-eye lens or a fly-eye lens pair.

18. The light source assembly according to claim 12, wherein
a plurality of beam combination mirrors in each beam combination mirror group are all inclined relative to a light-emitting surface of the laser; and
the plurality of beam combination mirrors reflect incident laser light toward a target direction, wherein the target direction is parallel to an arrangement direction of the plurality of beam combination mirrors; wherein
a part of beam combination mirrors among the plurality of beam combination mirrors reflect incident laser light to other beam combination mirrors; and
the other beam combination mirrors are dichroic mirrors, and configured to reflect incident laser light emitted from corresponding light-emitting areas and transmit the incident laser light emitted from other light-emitting areas.

19. The light source assembly according to claim 12, wherein the reflector support comprises an angle regulation element;
wherein an end of the angle regulation element is snapped into an accommodating slot of an inner wall of the second housing, and the angle regulation element is movable in the accommodating slot.

20. An optical engine, comprising:
a light source assembly;
a light modulation assembly; and
a lens;
wherein the light source assembly comprises:
a plurality of lasers, wherein at least two of the plurality of lasers are disposed in a portion of a same housing of the light source assembly, and are configured to emit lase light in three colors;
beam combination mirror groups, each for mixing laser light emitted from each of the at least two lasers;
a convex lens and a concave lens;
an angle adjustment element; and
a converging lens; wherein
the beam combination mirror group, the convex lens, the concave lens, the angle adjustment element and the converging lens are disposed in such a way that the laser light from each of the at least two lasers passes through the beam combination mirror group, the convex lens, the concave lens, the angle adjustment element and the converging lens in sequence in that order; and
the laser light emitted from each beam combination group does not overlap with each other and is incident on a position of the convex lens that is different from each other.
